(19) United States
(12) Patent Application Publication
(10) Pub. No.: US 2023/0311043 A1
(43) Pub. Date: Oct. 5, 2023

(54) FILTER ELEMENT CLAMP ASSEMBLY

(71) Applicant: SAUDI ARABIAN OIL COMPANY, Dhahran (SA)

(72) Inventors: Mahmoud Sabban, Dhahran (SA); Osama Zidan, Dhahran (SA)

(73) Assignee: SAUDI ARABIAN OIL COMPANY, Dhahran (SA)

(21) Appl. No.: 17/709,732

(22) Filed: Mar. 31, 2022

(51) Int. Cl. B01D 46/00

(52) U.S. Cl. CPC B01D 46/0002; B01D 2265/029

(57) ABSTRACT

Described is a filter element clamp assembly for securing filter elements in gas turbine and compressor air inlet systems. The filter element clamp assembly includes a filter wall of the air inlet system, a filter plate, inlet filters attached with the filter plate, and filter element clamps attached with the filter wall. Each filter element clamp is configured for fastening the filter plate to the filter wall, thereby securing the inlet filters in the air inlet system.

### BACKGROUND

Proper air filtration is critical to the overall performance and reliability of gas turbines. Failure of gas turbine inlet filters, due to design, human error, maintenance, or damage, results in dust particulate passing through the filter system and being ingested by the gas turbines. For sites with heavy dust loading in the ambient environment, such a failure results in heavy dust deposits on turbine blades. This has been a long technical challenge in Saudi Arabia and the Arabian gulf region, in particular, and worldwide, in general.

Many filter system failures have occurred due to dust ingestion related to filter elements moving out of the required position. Major sand deposits on gas turbine internals due to filter system failure ensue without the ability for early detection and/or reduction of the impact of a filter system failure. Many existing filter elements are attached with the filter wall using three pod yokes bolted to the filter wall separately. Each of the yokes is mounted to the filter wall with a single rod and washer mating mechanism. This configuration allows the filter element to move out of its proper position for a multitude of reasons, including improper installation, pulsation, tilting due to increased filter element weight, or an operator stepping on the filter elements. Currently, there are no reliable systems to eliminate improper installation of the filters, prevent looseness due to pulsation and, more importantly, prevent tilting due to increased filter weight or operator stepping on the filters.

Accordingly, there exists a need for a mechanism for securing filter elements in gas turbine and compressor air inlet systems which will provide reliability and strength to maintain the filter in position for the duration of the filter element usage, thereby preventing dust ingestion related to filter elements moving out of the required position.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a filter element clamp assembly. The filter element clamp assembly comprises a filter wall that is part of an existing air inlet system, a filter plate, at least one inlet filter attached with the filter plate, and a plurality of filter element clamps attached with the filter wall, wherein each filter element clamp is configured for fastening the filter plate to the filter wall, thereby securing the at least one inlet filter in the air inlet system.

In another aspect, embodiments disclosed herein relate to a method for securing an inlet filter in an air inlet system. The method includes using at least one clamp attached with a filter wall of the air inlet system, clamping a filter plate having at least one inlet filter attached therewith to the filter wall.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 is an illustration of a gas turbine ventilation system according to embodiments of the present disclosure;

FIG. 2 is an illustration of a filter element clamp assembly shown with an inlet filter according to embodiments of the present disclosure;

FIG. 3 is an illustration of a filter element clamp according to embodiments of the present disclosure;

FIG. 4 is an illustration of the filter element clamp assembly according to embodiments of the present disclosure; and

FIG. 5 is a flow diagram depicting a method for securing an inlet filter in an air inlet system according to embodiments of the present disclosure.

### DETAILED DESCRIPTION

In one aspect, embodiments disclosed herein relate to a filter element clamp assembly for securely attaching inlet filters to a filter wall in an air inlet system, such as gas turbine and compressor air inlet systems. Failure of gas turbine inlet filters, due to design, human error, maintenance, or damage, results in dust particulate bypassing the filter system and being ingested by the gas turbines. For sites with heavy dust loading in the ambient environment, such a failure results in heavy dust deposits on turbine blades. This has long been a technical challenge in Saudi Arabia and the Arabian gulf region, in particular, and worldwide, in general.

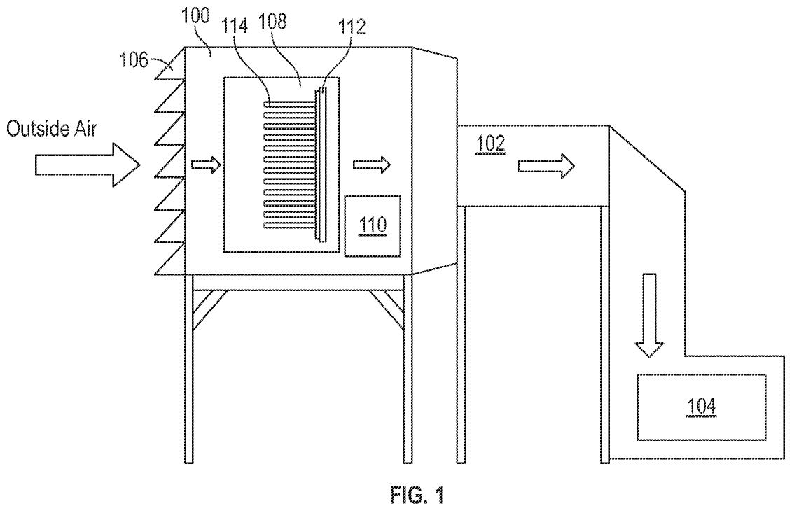

FIG. 1 illustrates one embodiment of a gas turbine ventilation system implementing the filter element clamp assembly described herein, which is designed to address the challenge described above. A typical gas turbine ventilation system includes a filter house (100) and ductwork (102) connecting the filter house (100) with a turbine and generator enclosure (104), which may house a turbine engine intake and turbine and generator compartments. The filter house (100) is comprised of weather hoods (106), filter element assemblies (108), and other components (110), such as cooling coils, evaporative media, and drift eliminators, among other components known by one skilled in the art. Air (represented by arrows) is ducted from the filter element assemblies (108) to the turbine and generator enclosure (104) for combustion via the turbine engine intake and to the turbine and generator compartments for cooling and ventilation. The filter element assemblies (108) are comprised of a filter wall (112) which positions and secure multiple inlet filters (114) within the filter house (100), as shown in FIG. 1.

Previous filters are typically attached with a filter wall using three pod yokes each attached with the filter wall separately. Yoke supports are located inside the inlet filter, and each yoke support (or yoke leg) is mounted to the filter wall with a single rod and washer mating mechanism. A bolt is inserted through holes in the yoke supports where the yoke supports meet, the bolt is inserted into a washer, and a nut screws on to the bolt, holding the parts together in a bolt assembly. A disadvantage of this design is that breakage may occur if someone stands on a yoke support during a filter change-out. Furthermore, this filter assembly allows the inlet filter to move out of its proper position for a multitude of reasons, including improper installation, pulsation, tilting due to increased filter element weight, or an operator stepping on the filter elements. There are no current reliable systems to eliminate improper installation of the filters, prevent looseness due to pulsation and, more importantly, prevent tilting due to increased filter weight or operator stepping on the filters. The filter element clamps and filter plate described below provide the extra assurance and strength to maintain the inlet filter in position for the duration of the filter element usage.

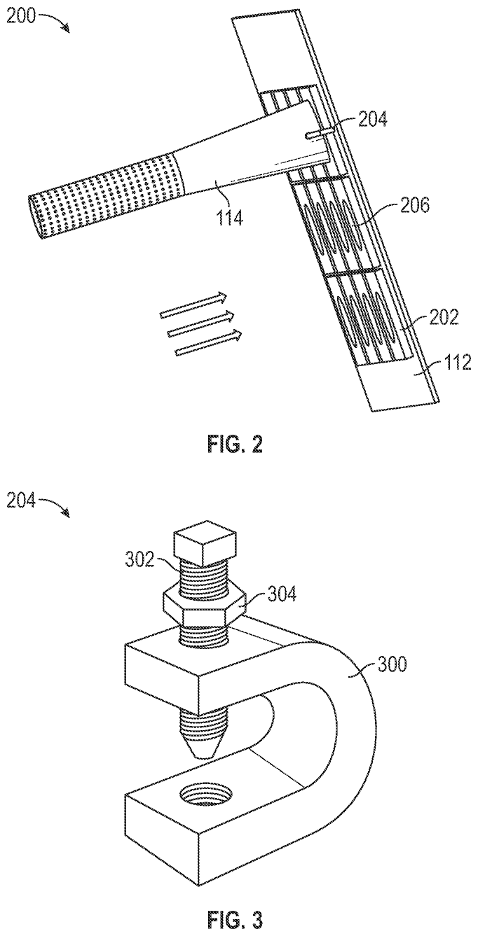

FIG. 2 depicts a filter element clamp assembly (200) according to embodiments of this disclosure. The filter element clamp assembly (200) comprises a filter wall (112), a filter plate (202), an inlet filter (114), and a filter element clamp (204). The filter wall (112) is an existing structure in the gas turbine ventilation system that is modified with filter element clamps (204). The inlet filter (114) is attached with the filter plate (202), which is then attached with the filter wall (112) via the filter element clamp (204). The filter plate (202) includes a plurality of apertures (206) therein for receiving inlet filters (114), such that an individual inlet filter (114) is attached with (or fits within) an aperture. Each filter element clamp (204) is securely attached with the filter wall (112) via an attachment process, such as welding or a bolt connection. In one or more embodiments, each filter element clamp assembly (200) comprises a set of four filter element clamps (204) attached with the filter wall (112). The filter plate (202) is clamped to the filter wall (112) using the filter element clamps (204).

In one or more embodiments, the set of filter element clamps (204) is positioned proximate an aperture (206) in the filter plate (202). Therefore, when an inlet filter (114) is attached with the aperture (206), the set of filter element clamps (204) are also proximate the inlet filter (114). The set of filter element clamps (204) prevents inlet filters (114) installed in gas turbine and compressor air inlet systems from moving from their proper position on the filter wall (112). As can be appreciated by one skilled in the art, any number of filter element clamps is possible provided that the clamps perform the intended function of maintaining the position of the inlet filter.

FIG. 3 illustrates an embodiment of the filter element clamp (204). The filter element clamp (204) is substantially curved in shape, similar to a C-clamp, and securely positions the filter plate to the filter wall, as shown in FIG. 2. In one or more embodiments, the filter element clamp (204) comprises a clamping member (300), a threaded fastener (e.g., bolt (302)), and a hardware nut (304). The bolt (302) screws into the hardware nut (304) to hold, or fasten, the filter plate to the filter wall. This configuration ensures that each filter plate and attached inlet filter is installed properly and stays in position for the lifetime of its usage, thereby preventing failures due to dust ingestion related to a filter element moving out of its required position for proper use.

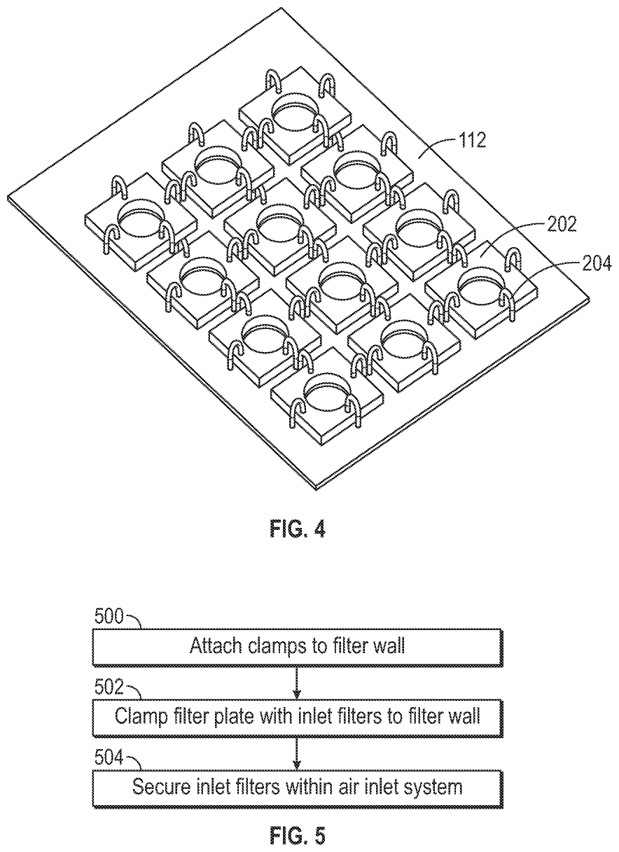

FIG. 4 illustrates filter plates (202) clamped to the filter wall (112) without any inlet filters to clearly show placement of the filter element clamps (204) around an aperture (206) of the filter plate (202). In one or more embodiments, the filter plate (202) and inlet filter are manufactured and sold as one piece. Alternatively, the filter plate (202) and inlet filter may be manufactured and sold separately and then assembled prior to use. The filter plate (202) may be fitted to different types of filters.

FIG. 5 is a flow diagram depicting a method for securing an inlet filter in an air inlet system. In an initial step (500), filter element clamps, as described above, are attached to a filter wall. In a subsequent step (502), a filter plate with attached inlet filters is clamped to the filter wall via the filter element clamps. In a final step (504), the inlet filters are secured within the air inlet system.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A filter element clamp assembly, comprising:
a filter wall of an air inlet system;
a filter plate;
at least one inlet filter attached with the filter plate; and
a plurality of filter element clamps attached with the filter wall, wherein each filter element clamp is configured for fastening the filter plate to the filter wall, thereby securing the at least one inlet filter in the air inlet system.

2. The filter element clamp assembly as set forth in claim 1, wherein the filter plate comprises a plurality of apertures, each aperture formed to attach an inlet filter with the filter plate.

3. The filter element clamp assembly as set forth in claim 1, wherein each filter element clamp is substantially curved in shape.

4. The filter element clamp assembly as set forth in claim 1, wherein each filter element clamp comprises a clamping member, a threaded fastener, and a hardware nut.

5. The filter element clamp assembly as set forth in claim 1, wherein the plurality of filter element clamps comprises four filter element clamps.

6. A method for securing an inlet filter in an air inlet system, comprising:
using at least one clamp attached with a filter wall of the air inlet system, clamping a filter plate having at least one inlet filter attached therewith to the filter wall.

7. The method as set forth in claim 6, wherein the filter plate comprises a plurality of apertures, each aperture formed to attach an inlet filter with the filter plate.

8. The method as set forth in claim 6, wherein each filter element clamp is substantially curved in shape.

9. The method as set forth in claim 6, wherein each filter element clamp comprises a clamping member, a threaded fastener, and a hardware nut.

10. The method as set forth in claim 6, wherein the plurality of filter element clamps comprises four filter element clamps.
